(19) United States
(12) Patent Application Publication
(10) Pub. No.: US 2026/0264861 A1
(43) Pub. Date: Sep. 10, 2026

(54) DEVICES FOR VEHICLE CONSOLE ASSEMBLIES

(71) Applicant: SUPERNAL, LLC, Washington, DC (US)

(72) Inventors: Alexander Pozzi, Carlsbad, CA (US); Benjamin Stephens, Winston-Salem, NC (US)

(21) Appl. No.: 18/880,187

(22) PCT Filed: Jun. 30, 2023
(86) PCT No.: PCT/US2023/026682

§ 371 Date: Dec. 30, 2024

Related U.S. Application Data
(60) Provisional application No. 63/367,555, filed on Jul. 1, 2022.
(60) Provisional application No. 63/368,564, filed on Jul. 15, 2022.

(51) Int. Cl. B64D 11/06

(52) U.S. Cl. CPC B64D 11/0644; B64D 11/0636

(57) ABSTRACT

A console assembly includes an upper portion including a top surface, at least two side surfaces extending from the top surface, and an upper portion volume, and a lower portion including a bottom surface, at least two side surfaces extending from the bottom surface, and a lower portion volume. The lower portion volume is smaller than the upper portion volume, and the upper portion moves between a raised position and a lowered position.

### CROSS-REFERENCE TO RELATED APPLICATIONS

This application claims priority to U.S. Provisional Application No. 63/367,555, filed on Jul. 1, 2022 and U.S. Provisional Application No. 63/368,564, filed on Jul. 15, 2022, the entire contents of each of which are incorporated herein by reference.

### BACKGROUND

Many people travel via aircraft transportation. With the increase in the number of flights and the number of passengers traveling, efficient passenger boarding and deplaning remains a prominent issue. In conventional seating assemblies, armrests do not change position, do not easily change position, or change position in a way that partially obstructs movement from one seat to another seat. This can slow down passengers attempting to ingress or egress a seat of seats on an aircraft. Additionally, current armrests have been a point of public debate and frustration concerning the lack of personal space on aircrafts and which passenger may appropriately use which armrest, particularly where the armrest may be shared between two seats.

Conventional armrests have become an outsized symbolic importance in the passenger experience. Passenger frustration concerning lack of personal space and which passenger gets which armrest has intensified resentment among passengers traveling via aircrafts. Moreover, not only may passengers experience difficulties entering a row with their personal belongings, but passengers also experience difficulties leaving a row in case of emergency or to use the bathroom. This results in increased frustration with flight personnel and passengers. Conventional armrests on aircraft rows between seats remain at the front of many of these issues revolving around passenger frustration and inefficient boarding and deboarding of aircrafts. Aircrafts also possess limited storage areas in the form of cargo storage beneath aircraft cabins and overhead passenger bins. Further, during emergency landings or deplaning events, armrests may obstruct passengers attempting to leave the plane for safety.

Conventional armrests remain inadequate in their current state. Accordingly, the present invention seeks to provide an improved console assembly which can replace or supplement conventional armrests to both provide flexible support for passengers' comfort as well as to maximize storage area for passengers' belongings. Console assemblies may also provide other amenities such as USB ports and wireless charging for passengers' electronic devices.

The embodiments of the console assembly disclosed herein may be used to replace and/or supplement conventional armrests and the seating assembly disclosed herein may be used to replace seating assemblies on passenger vehicles.

### SUMMARY

The present disclosure describes implementations that relate to a console, a seating assembly, and combinations thereof.

In a first example embodiment, the present disclosure describes a console assembly including an upper portion including a top surface, at least two side surfaces extending from the top surface, and an upper portion volume, and a lower portion including a bottom surface, at least two side surfaces extending from the bottom surface, and a lower portion volume, where the lower portion volume is smaller than the upper portion volume. The upper portion is configured to move between a raised position and a lowered position.

In a further example embodiment, the present disclosure describes a seating assembly including at least two seats, each seat including a seat surface, and a console assembly disposed between the at least two seats, the console assembly including an upper portion and a lower portion. The upper portion includes a top surface, at least two side surfaces extending from the top surface, and an upper portion volume. The lower portion includes a bottom surface, at least two side surfaces extending from the bottom surface, and a lower portion volume, the lower portion volume being smaller than the upper portion volume. The upper portion is configured to move between a raised position and a lowered position.

The foregoing summary is illustrative only and is not intended to be in any way limiting. In addition to the illustrative aspects, implementations, and features described above, further aspects, implementations, and features will become apparent by reference to the drawings and the following detailed description.

### BRIEF DESCRIPTION OF THE DRAWINGS

FIG. 1A depicts a seating assembly in a first configuration according to an example embodiment of the present invention.

FIG. 1B depicts the seating assembly of FIG. 1A in a second configuration according to an example embodiment of the present invention.

FIG. 2 depicts an example use case of a seating assembly according to an example embodiment of the present invention.

FIG. 3A depicts a perspective view of a console assembly in a first position according to an example embodiment of the present invention.

FIG. 3B depicts a perspective view of the console assembly of FIG. 3A in a second position according to an example embodiment of the present invention.

FIGS. 4A-4B depict a front view of a console assembly in a first and second position, respectively, according to an example embodiment of the present invention.

FIG. 4C depicts a side view of the console assembly of FIGS. 4A-B according to an example embodiment of the present invention.

### DETAILED DESCRIPTION

Disclosed herein are examples of assemblies and systems for a console, which may be utilized in vehicles, such as aircraft (e.g., airplanes, helicopters, airships, VTOL vehicles, unmanned aerial vehicles, drones, and hot air balloons), ground vehicles (e.g., cars, trucks, buses), rail vehicles (e.g., trains, unmanned trains), or water vehicles (e.g., boats, submersibles), for example.

Embodiments described herein may include a console assembly including an upper portion and a lower portion, the upper portion movable between a raised position and a lowered position. Beneficially, these embodiments may include a lower portion volume which can be used as additional storage space on a vehicle. The lower portion volume may be accessible when the upper portion is in the raised position.

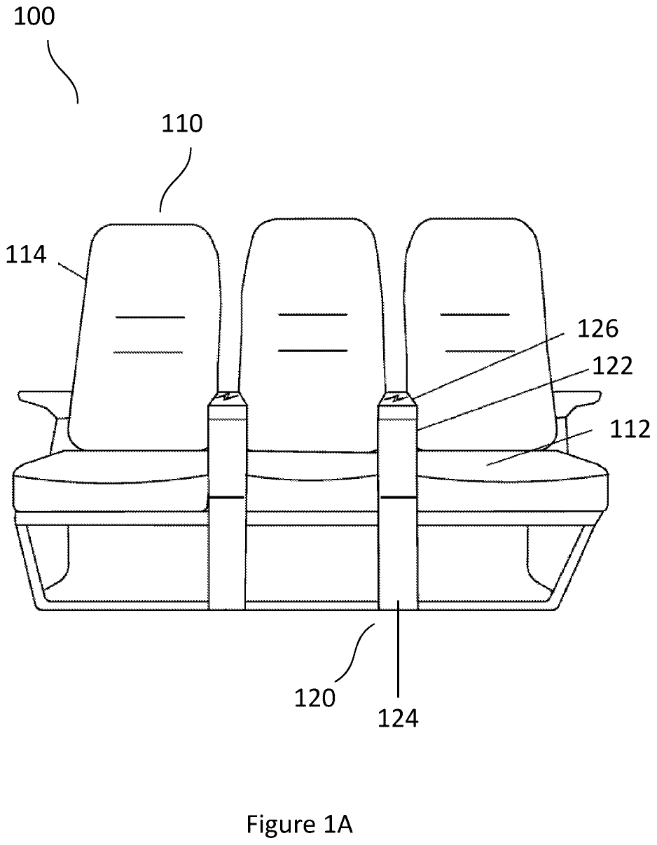

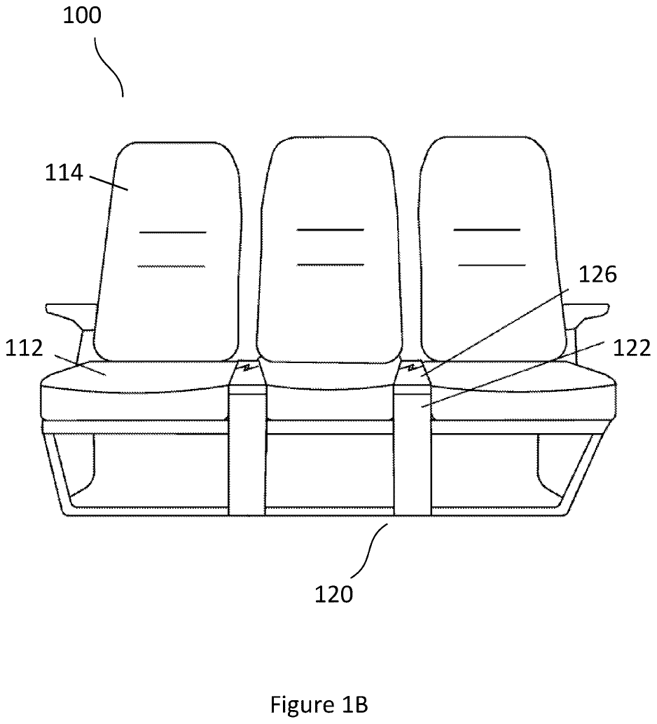

As illustrated by FIGS. 1A and 1B, the present disclosure describes a seating assembly 100 which includes at least one seat 110 and at least one console assembly 120. The seat 110 includes a seating surface 112 and a support surface 114. The console assembly 120 includes an upper portion 122 having a top surface 126 and a lower portion 124. As depicted in FIG. 1A, when the upper portion 122 is in a raised position, the top surface 126 is positioned above the seating surface 112. When the upper portion 122 is in a lowered position, the top surface 126 is aligned with the seating surface 112, as depicted in FIG. 1B. When the upper portion 122 is in the lowered position, the upper portion 122 encompasses the lower portion 124. As illustrated in FIG. 1B, when the upper portion 122 is in the lowered position, a user may have easier access to at least one seat 110.

In some embodiments, the top surface 126 of the upper portion 122 may include a padded surface which may be used as an armrest. In further embodiments, the top surface 126 of the upper portion 122 may include various amenities, such as electronic charging ports, wireless charging pads for mobile electronic devices, cup holders, and a display screen. In some embodiments, the top surface 126 of the upper portion 122 may be used as a seating surface, such as when the upper portion 122 is in the lowered position and the top surface 126 is aligned with the seating surface 112.

Although the console assembly 120 is illustrated as being positioned between at least two seats 110, in some embodiments, the console assembly 120 may be positioned on one side of one seat. Additionally, in some embodiments, the top surface of the upper portion of a console assembly may provide support for a passenger's arm and elbow to rest on, and the console assembly may be adjusted individually to allow passengers of different shapes and sizes to adjust the location of the console assembly for their own personal comfort.

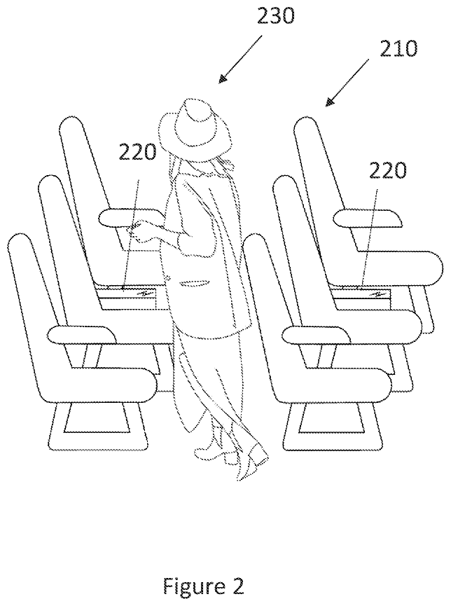

As illustrated by FIG. 2, when a console assembly 220 is in the lowered position, a passenger 230 of an aircraft may easily ingress or egress a row of one or more seats 210 for easy access to the passenger's seat.

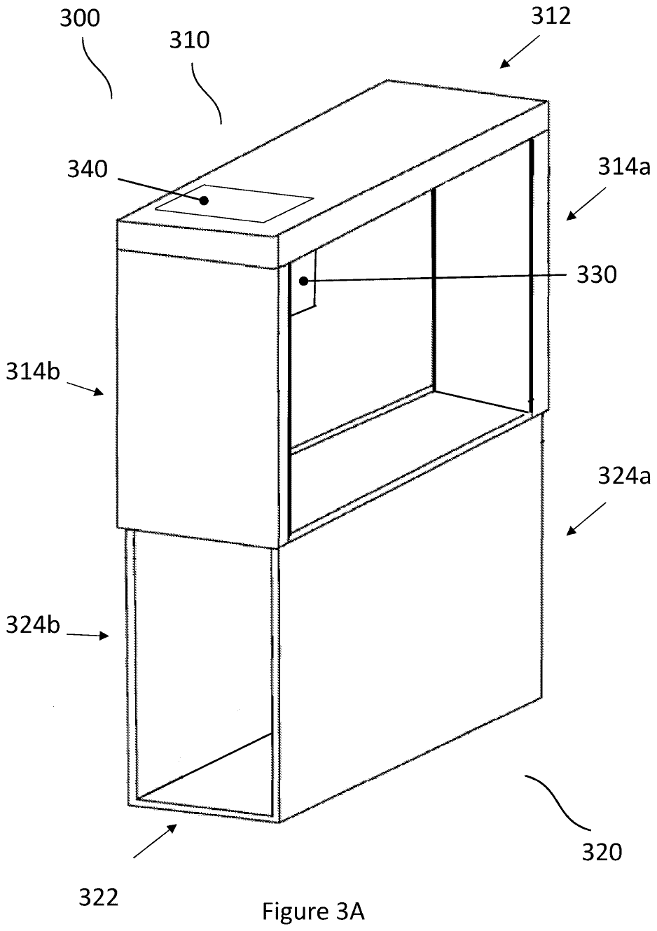

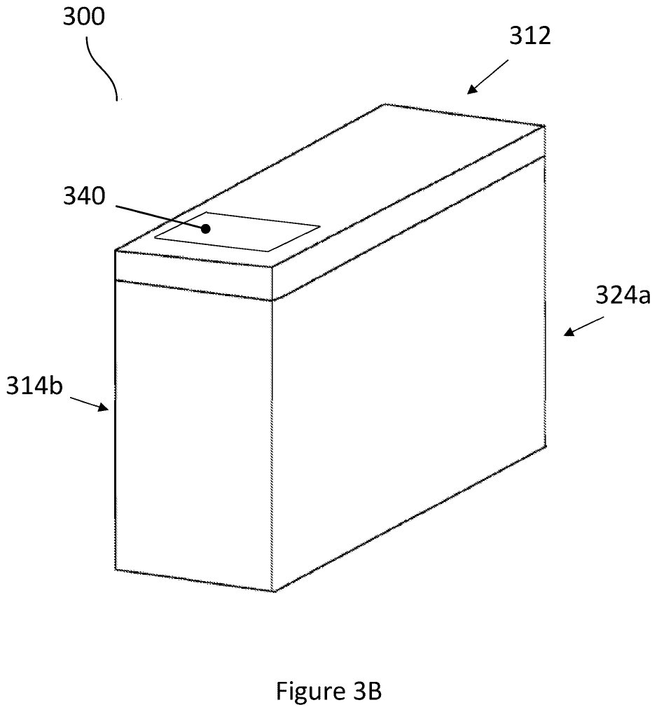

FIGS. 3A-3B illustrate a perspective view of an example console assembly, according to exemplary embodiments of the present disclosure.

The console assembly 300 may include an upper portion 310 including a top surface 312, at least two side surfaces 314a and 314b extending from the top surface 312, and an upper portion volume contained between the top surface 312 and the at least two side surfaces 314a, 314b. The console assembly 300 may further include a lower portion 320 including a bottom surface 322, at least two side surfaces 324a and 324b extending from the bottom surface 322, and a lower portion volume contained between the bottom surface 322 and the at least two side surfaces 324a, 324b, which may function as a storage area. The upper portion 310 is movable between a raised position, illustrated in FIG. 3A, and a lowered position, illustrated in FIG. 3B. The at least two side surfaces 314a, 314b of the upper portion 310 may be positioned in a different or opposite configuration from the at least two side surfaces 324a, 324b of the lower portion 320, such that when the upper portion 310 is in the lowered position, the side surfaces 314a, 314b, 324a, 324b, form the perimeter of a box, as illustrated in FIG. 3B. The console assembly 300 further includes an electric motor 330 and a control panel 340 disposed on the top surface 312. The electric motor 330 may be configured to move the upper portion 310 between the raised position and the lowered position. In some embodiments, the electric motor 434 may be coupled to the control panel 340 on the top surface 312. In such embodiments, a user can control the movement of the upper portion 310. The control panel 340 may include at least one button, switch, dial, or other suitable means for allowing a passenger to send commands to the electric motor 330 to raise or lower the upper portion 310. In some embodiments, the control panel 340 may include an electronic touch screen configured to send signals to the electric motor 330. The signals may be sent to the electric motor 330 by a wired connection, or by a wireless connection, such as by Wi-Fi or Bluetooth®, or by any other suitable means.

When the upper portion 310 is in the raised position, the lower portion volume is accessible by the area between the side surfaces 314a, 314b extending from the top surface 312. The lower portion volume may also be accessed by the area below the side surface 314b and between the side surfaces 324a, 324b extending from the bottom surface 322. Such a configuration allows a passenger to access the storage area of the console assembly 300 from various positions. Further, when the upper portion 310 is in the lowered position and the side surfaces 314a, 314b, 324a, 324b form the perimeter of a box, any items stored in the storage area may be contained, preventing the items from shifting out of the console assembly 310 while the vehicle is in motion or in a take-off or landing sequence.

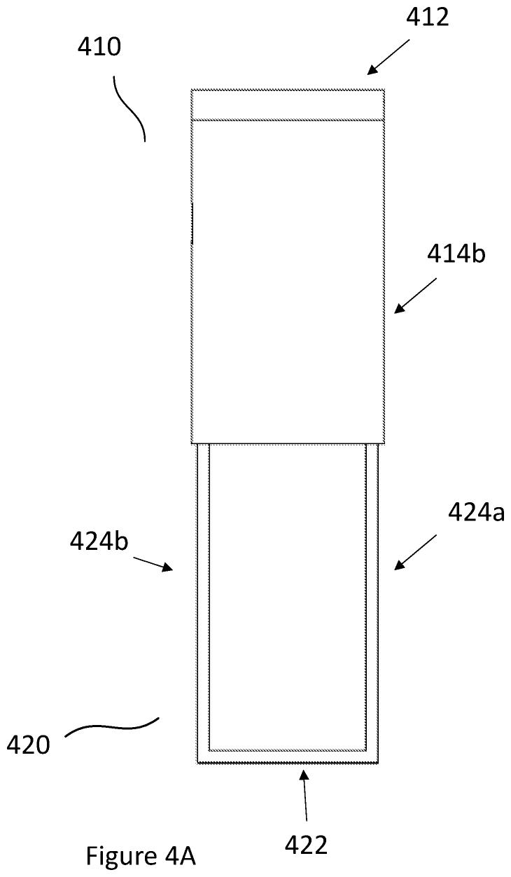

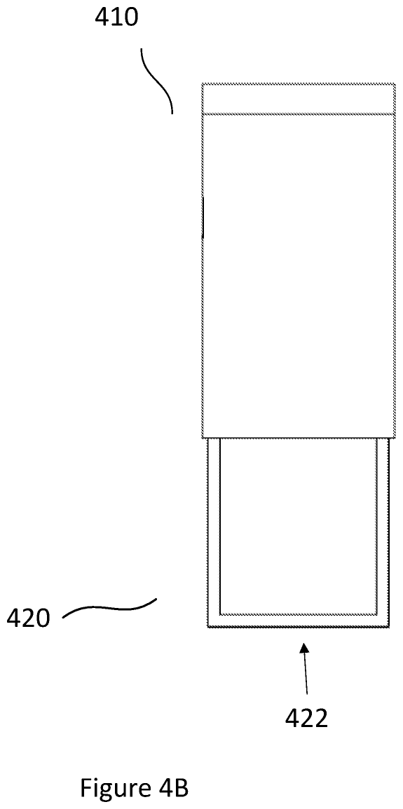

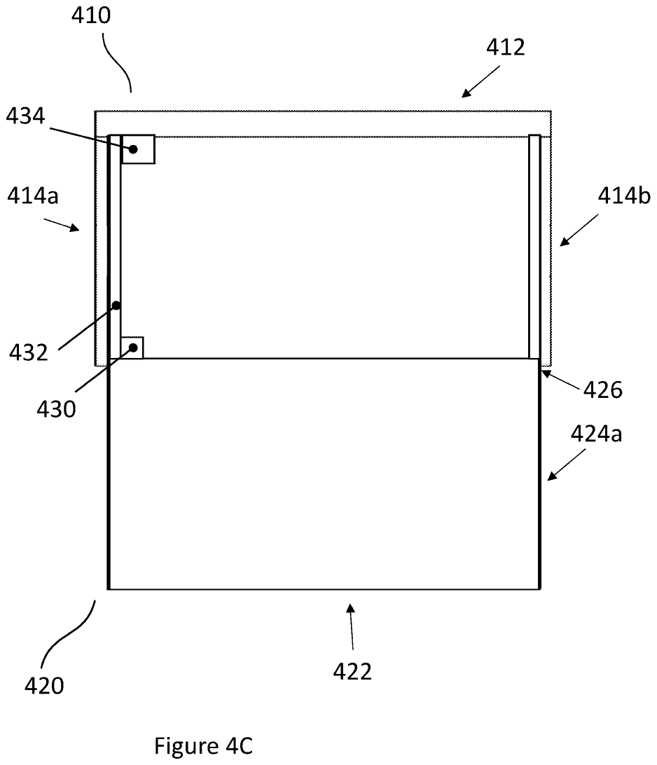

FIGS. 4A-4C depict front and side views of a console assembly according to an example embodiment of the present disclosure. The console assembly 400 includes an upper portion 410, a lower portion 420, a locking mechanism 430, a telescoping slide assembly 432, and an electric motor 434.

The upper portion 410 may include a top surface 412, at least two side surfaces 414a, 414b extending from the top surface 412, and an upper portion volume contained between the top surface 412 and the side surfaces 414a, 414b. The telescoping slide assembly 432 may be coupled to the upper portion 410 or the lower portion 420, or any combination thereof. The telescoping slide assembly 432 can connect the upper portion 410 to the lower portion 420, such than when the upper portion 410 moves between a raised position and a lowered position, the parts of the telescoping slide assembly 432 move relative to each other, allowing the upper portion 410 to slide between the raised position and the lowered position. The lower portion 420 may include a bottom surface 422, at least two side surfaces 424a, 424b extending from the bottom surface 422, a horizontal surface 426 parallel to the bottom surface 422 at a height above the bottom surface 422, and a lower portion volume contained between the bottom surface 422, the side surfaces 424a, 424b, and the horizontal surface 426. When the upper portion 410 is in the lowered position, the top surface 412 may rest on top of the horizontal surface 426.

The locking mechanism 430 may be coupled to the console assembly 400 and configured to hold the upper portion 410 at a particular position. For example, as illustrated in FIG. 4B, the upper portion may be positioned at a point between the raised position and the lowered position, and the locking mechanism 430 may be engaged to hold the upper portion 410 at that position. The locking mechanism 430 may also be engaged to hold the upper portion 410 in the lowered position. In some embodiments, the locking mechanism 430 may be configured to lock the top surface 412 to the horizontal surface 426.

In some embodiments, the locking mechanism 430 may comprise any mechanical or electrical mechanism known to those skilled in the art, including, but not limited to one or more fasteners, stops, latches, or pins. In some embodiments, the console assembly 400 may include a quick-release that allows the upper portion 410 to be unlocked from its position relative to the lower portion 420. In some embodiments, the quick-release may release the locking mechanism and allow gravity or a user to move the upper portion from the locked position. The quick-release may include a button, a lever, a latch handle, a pin, a detent, or any other user operator release known to one skilled in art.

In some embodiments, the electric motor 434 may be configured to move the upper portion 410 along the telescoping slide assembly 432. In some embodiments, the electric motor 434 may be coupled to a control panel on the top surface 412. In such embodiments, a user can control the movement of the upper portion 410. The top surface 412 may include at least one button, switch, dial, or other suitable means for allowing a passenger to send commands to the electric motor 434 to raise or lower the upper portion 410. In some embodiments, the top surface 412 may include an electronic touch screen configured to send signals to the electric motor 434. The signals may be sent to the electric motor 434 by a wired connection, or by a wireless connection, such as by Wi-Fi or Bluetooth®, or by any other suitable means.

In some embodiments, the electric motor 34 may be coupled to a controller, such that the upper portion 410 may be automatically or remotely controlled to move between the raised position and the lowered position. Beneficially, in some embodiments, the controller may be configured to automatically retract the upper portion of the console assembly in the case of an emergency, a deplaning command (e.g., associated with a compartment door opening or a deplaning command by a flight crew member), or after a predetermined time (e.g., at the end of a scheduled flight). Further, the console assembly may be commanded to move between a raised and lowered position based on a signal sent by a flight crew member or a pilot, in synchronization with a plurality of console assemblies on the vehicle.

In some embodiments, a console assembly includes an upper portion comprising a top surface, at least two side surfaces extending from the top surface, and an upper portion volume, and a lower portion comprising a bottom surface, at least two side surfaces extending from the bottom surface, and a lower portion volume. The lower portion volume is smaller than the upper portion volume and the upper portion is configured to move between a raised position and a lowered position.

In some embodiments, the upper portion further includes a locking mechanism, the locking mechanism configured to engage when the upper portion is in the raised position or in the lowered position.

In some embodiments, the top surface of the upper portion comprises a padded surface.

In some embodiments, the top surface of the upper portion comprises at least one electronic connection port.

In some embodiments, when the upper portion is in the raised position, the lower portion volume is accessible by an area disposed between the at least two side surfaces of the upper portion.

In some embodiments, the upper portion is further configured to rest at a plurality of positions between the raised position and the lowered position.

In some embodiments, the console assembly further includes a telescoping slide assembly coupled to the upper portion and the lower portion.

In some embodiments, the console assembly further includes an electronic motor system, the electronic motor system configured to move the upper portion between the raised position and the lower position.

In some embodiments, the upper portion further comprises a control panel coupled to the electronic motor system.

In some embodiments, the lower portion further includes a horizontal surface parallel to the bottom surface, the horizontal surface positioned at a height above the bottom surface.

In some embodiments, a seating assembly includes at least two seats, each seat including a seat surface, and a console assembly disposed between the at least two seats, the console assembly including an upper portion and a lower portion. The upper portion includes a top surface, at least two side surfaces extending from the top surface, and an upper portion volume. The lower portion includes a bottom surface, at least two side surfaces extending from the bottom surface, and a lower portion volume, the lower portion volume being smaller than the upper portion volume. The upper portion is configured to move between a raised position and a lowered position.

In some embodiments, when the upper portion is in the raised position, the top surface of the upper portion is positioned above the seat surface.

In some embodiments, when the upper portion is in the lowered position, the top surface of the upper portion is aligned with the seat surface.

In some embodiments, the console assembly further includes a locking mechanism disposed on one of the at least two side surfaces of the upper portion, the locking mechanism configured to hold the upper portion in the raised position or the lowered position.

In some embodiments, the top surface of the upper portion of the console includes a flat surface, the flat surface configured to be a seating surface when the upper portion is in the lowered position.

In some embodiments, the console assembly further includes at least one of a seatbelt or a car seat restraint.

In some embodiments, the upper portion of the console further includes at least one of an electronic charging port, a display screen, and/or a cupholder assembly.

In some embodiments, the console assembly further includes an electronic controller and motor system configured to move the upper portion of the console from the raised position to the lowered position.

In some embodiments, the top surface of the upper console includes a control panel coupled to the electronic controller and motor system, the control panel comprising at least one button, switch, or dial.

In some embodiments, the lower portion volume is accessible when the upper portion is in the raised position or in the lowered position.

The present disclosure describes various features and operations of the disclosed systems. The illustrative implementations described herein are not meant to be limiting. Certain aspects of the disclosed systems can be arranged and combined in a variety of different configurations, all of which are contemplated herein.

Further, unless context suggests otherwise, the features illustrated in each of the figures may be used separately or in combination. Thus, the figures should be generally viewed as component aspects of one or more overall implementations, with the understanding that not all illustrated features are necessary for each implementation.

Additionally, any enumeration of elements, blocks, or steps in this disclosure is for purposes of clarity. Thus, such enumeration should not be interpreted to require or imply that these elements, blocks, or steps adhere to a particular arrangement or are carried out in a particular order.

Further, devices or systems may be used or configured to perform functions presented in the figures. In some instances, components of the devices and/or systems may be configured to perform the functions such that the components are actually configured and structured (with hardware and/or software) to enable such performance. In other examples, components of the devices and/or systems may be arranged to be adapted to, capable of, or suited for performing the functions, such as when operated in a specific manner.

The arrangements described herein are for purposes of example only. As such, those skilled in the art will appreciate that other arrangements and other elements (e.g., machines, interfaces, operations, orders, and groupings of operations, etc.) can be used instead, and some elements may be omitted altogether according to the desired results. Further, many of the elements that are described are functional entities that may be implemented as discrete or distributed components or in conjunction with other components, in any suitable combination and location.

While various aspects and implementations have been disclosed herein, other aspects and implementations will be apparent to those skilled in the art. The various aspects and implementations disclosed herein are for purposes of illustration and are not intended to be limiting. Also, the terminology used herein is for the purpose of describing particular implementations only and is not intended to be limiting.

1. A console assembly comprising:
an upper portion comprising a top surface, at least two side surfaces extending from the top surface, and an upper portion volume; and
a lower portion comprising a bottom surface, at least two side surfaces extending from the bottom surface, and a lower portion volume, wherein the lower portion volume is smaller than the upper portion volume;
wherein the upper portion is configured to move between a raised position and a lowered position.

2. The console assembly of claim 1, wherein the upper portion further comprises a locking mechanism, the locking mechanism being configured to engage when the upper portion is in the raised position or in the lowered position.

3. The console assembly of claim 1, wherein the top surface of the upper portion comprises a padded surface.

4. The console assembly of claim 1, wherein the top surface of the upper portion comprises at least one electronic connection port.

5. The console assembly of claim 1, wherein when the upper portion is in the raised position, the lower portion volume is accessible by an area disposed between the at least two side surfaces of the upper portion.

6. The console assembly of claim 1, wherein the upper portion is further configured to rest at a plurality of positions between the raised position and the lowered position.

7. The console assembly of claim 1 further comprising a telescoping slide assembly coupled to the upper portion and the lower portion.

8. The console assembly of claim 1 further comprising an electronic motor system, the electronic motor system being configured to move the upper portion between the raised position and the lower position.

9. The console assembly of claim 8, wherein the upper portion further comprises a control panel configured to control the electronic motor system.

10. The console assembly of claim 1, wherein the lower portion further comprises a horizontal surface parallel to the bottom surface, the horizontal surface being positioned at a height above the bottom surface.

11. A seating assembly comprising:
at least two seats, each seat comprising a seat surface; and
a console assembly disposed between the at least two seats, the console assembly comprising an upper portion and a lower portion, wherein the upper portion comprises a top surface, at least two side surfaces extending from the top surface, and an upper portion volume, and the lower portion comprises a bottom surface, at least two side surfaces extending from the bottom surface, and a lower portion volume, the lower portion volume being smaller than the upper portion volume;
wherein the upper portion is configured to move between a raised position and a lowered position.

12. The seating assembly of claim 11, wherein when the upper portion is in the raised position, the top surface of the upper portion is positioned above the seat surface.

13. The seating assembly of claim 11, wherein when the upper portion is in the lowered position, the top surface of the upper portion is aligned with the seat surface.

14. The seating assembly of claim 11, wherein the console assembly further comprises a locking mechanism disposed on one of the at least two side surfaces of the upper portion, wherein the locking mechanism is configured to hold the upper portion in the raised position or in the lowered position.

15. The seating assembly of claim 11, wherein the top surface of the upper portion of the console comprises a flat surface, the flat surface configured to be a seating surface when the upper portion is in the lowered position.

16. The seating assembly of claim 15, wherein the console assembly further comprises at least one of a seatbelt or a car seat restraint.

17. The seating assembly of claim 11, wherein the upper portion of the console further comprises at least one of an electronic charging port, a display screen, and/or a cupholder assembly.

18. The seating assembly of claim 11 further comprising an electronic controller and motor system configured to move the upper portion of the console from the raised position to the lowered position.

19. The seating assembly of claim 18, wherein the top surface of the upper console comprises a control panel coupled to the electronic controller and motor system, the control panel comprising at least one button, switch, or dial.

20. The seating assembly of claim 11, wherein the lower portion volume is accessible when the upper portion is in the raised position or in the lowered position.
